(19) United States
(12) Patent Application Publication
(10) Pub. No.: US 2010/0006600 A1
(43) Pub. Date: Jan. 14, 2010

(54) FLUID DISPENSER INCLUDING HYDROPHOBIC RING

(76) Inventor: Gustavo A. Dascanio, Los Olivos, CA (US)

Correspondence Address: HUGH P. GORTLER, 23 ARRIVO DRIVE, MISSION VIEJO, CA, 92692, US

(21) Appl. No.: 12/173,013

(22) Filed: Jul. 14, 2008

(51) Int. Cl. B67D 5/16

(52) U.S. Cl. 222/71

(57) ABSTRACT

Apparatus for metering and dispensing fluid includes a fluid dispensing section having an exit orifice, a fluid inlet, and a pathway extending from the fluid inlet to the exit orifice. A portion of the pathway includes a hydrophilic portion for metering a volume of the fluid when the dispensing section is upright; and a hydrophobic ring at the fluid inlet for preventing a metered volume from flowing out of the hydrophilic portion when the dispensing section is upright. The apparatus further includes a one-way valve between the exit orifice and the hydrophilic portion for allowing fluid to flow out of the hydrophilic portion and toward the exit orifice when sufficient pressure is applied to the fluid inlet. The one-way valve also prevents fluid from flowing through the exit orifice when the hydrophilic portion is being filled with fluid.

### BACKGROUND

Eye drops can contain medicines for treating eye diseases and conditions. Eye drops can contain lubricants for relieving eye dryness.

Preservatives can increase the shelf life of eye drops and allow multiple doses of eye drops to be dispensed from a single dispenser. However, eye drops containing preservatives can cause problems, such as allergic reactions and ocular irritation.

Preservative-free drops can avoid allergic reactions and ocular irritation. However, a squeeze bottle or other dispenser of preservative-free eye drops must prevent air and other unsterilized fluid from entering into the dispenser. Otherwise, preservative-free eye drops within the dispenser can become contaminated.

### BRIEF DESCRIPTION OF THE DRAWINGS

FIG. 1 is an illustration of a fluid dispenser for dispensing a metered volume of fluid.

FIGS. 2a-2c are illustrations of a one-way valve for the fluid dispenser.

FIG. 3 is an illustration of a series of one-way valves for the fluid dispenser.

FIG. 4 is an illustration of an eye drop dispenser.

FIGS. 5-7 are illustrations of fluid dispensers that use different approaches towards replacing a metered volume with a sterile gas.

### DETAILED DESCRIPTION

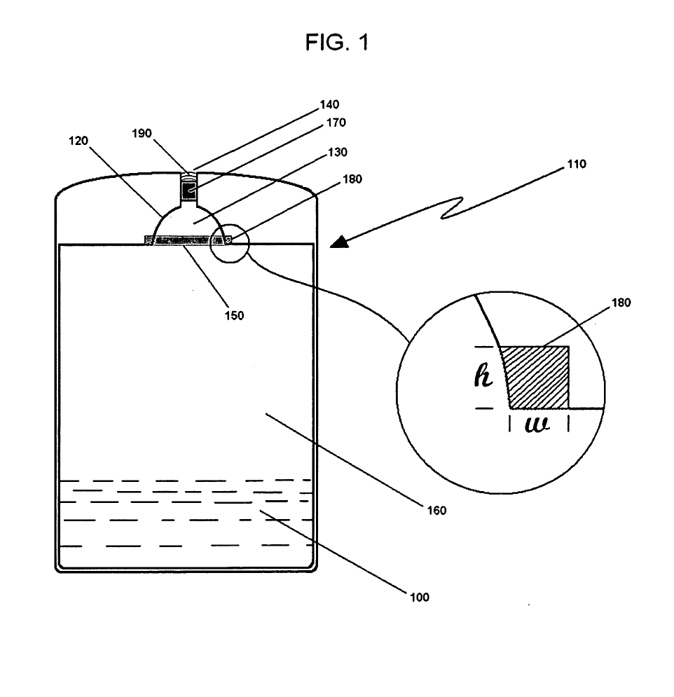

Reference is made to FIG. 1, which illustrates a fluid dispenser 110 including a dispensing section 120 for metering and dispensing volumes of fluid 100. The dispensing section 120 has a dispensing chamber 130, an exit orifice 140 and a fluid inlet 150. The dispensing chamber 130 could be conical, cylindrical, hemispherical, or some other shape. The fluid inlet 150 of the dispensing section 120 is in fluid communication with a fluid container 160. In some embodiments, the fluid container 160 may be a bottle, and the dispensing section 120 may be part of a removable closure for one end of the fluid container 160. In some embodiments, the dispensing section 120 may be integral with the fluid container 160.

The dispensing chamber 130 is part of a fluid pathway extending from the fluid inlet 150 to the exit orifice 140. At least a portion of the fluid pathway (e.g., the entire chamber 130) is made of hydrophilic (i.e., wettable) material. The hydrophilic material could be a clean plastic such as polyethylene. Most clean plastic materials are hydrophilic.

A one-way exit valve 170 is located along the fluid pathway, between the chamber 130 and the exit orifice 140. The one-way valve 170 allows fluid to flow out of the chamber 130 and toward the exit orifice 140 when sufficient pressure (an “opening pressure”) is applied to the fluid inlet 150. Otherwise, the one-way valve 170 prevents unsterile air or other fluid from flowing through the exit orifice 140 and into the chamber 130 and fluid container 160. Thus, the one-way valve 170 prevents unsterile air from “contaminating” fluid 100 in the container 160.

When the fluid dispenser 110 is inverted, fluid 100 from the container 160 flows into and fills the dispensing chamber 130. So long as an opening pressure is not applied, the one way valve 170 prevents fluid from flowing out of the chamber 130 as the chamber 130 is being filled.

When the fluid dispenser 110 is returned to an upright position, a volume of fluid is retained in the dispensing chamber 130. This volume will be referred to as a “metered volume.” The metered volume is held in the chamber 130 in part due to surface tension forces. Adhesive forces of the liquid molecules to the dispensing chamber surface are greater than the cohesive forces of the liquid (i.e. there is a greater attraction of the liquid to the surface than between the particles of the liquid). This causes the fluid to “stick” to the surface and, hence, be retained in the dispensing chamber 130.

The dispensing section 120 further includes a ring 180 at the fluid inlet 150. The ring 180 is made of hydrophobic (i.e., non-wettable) material. The hydrophobic material could be silicone rubber or Teflon. Aqueous liquids on a hydrophobic surface tend to disperse, as the cohesive forces of attraction between the particles of the liquid are greater than the adhesive forces of the surface. That is, there is a greater attraction between the particles of the liquid than between the surface and the liquid. Therefore, liquid will not wet the surface of the hydrophobic ring 180. The hydrophobic ring 180 may be located just inside the dispensing chamber 130 or at the end of the dispensing chamber 130. When the dispensing section 120 is returned to its upright position, a hydrophobic ring 180 of sufficient thickness will prevent fluid 100 in the dispensing chamber 130 from “wicking” out by interrupting the flow over the surface of the fluid inlet 150. Thus, the combination of surface tension forces from the hydrophilic chamber 130 and the hydrophobic ring 180 prevent the metered volume from flowing out of the chamber 130 and back into the container 160. An exemplary cross-section of the hydrophobic ring has a height h of about 1 to 2 millimeters and a width w of about 1 to 2 millimeters.

The metered volume is dispensed through the exit orifice 140 by applying the opening pressure at the fluid inlet 150. For example, if the fluid container 160 is a squeeze bottle, the opening pressure may be applied by squeezing the bottle. Sufficient pressure at the fluid inlet 150 causes the one-way valve 170 to open, and the metered volume to be expelled through the exit orifice 140.

The one-way valve 170 of a fluid dispenser described herein is not limited to any particular type. For example, the one-way valve could be a spring-loaded valve that allows fluid to flow in only one direction.

Another type of one-way valve is disclosed in U.S. Pat. No. 5,685,869. The valve has a “seam” which is normally closed and keeps out contaminants, but opens under sufficient pressure to allow fluid to pass. This valve has a flexible outer portion which “gives” under pressure to allow fluid to pass.

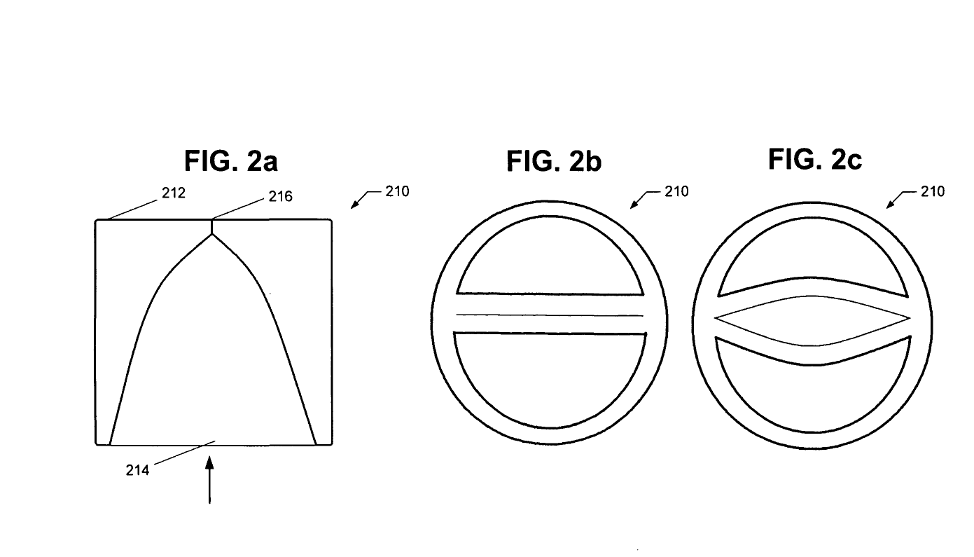

Reference is made to FIGS. 2a-2c, which illustrate another example of a one-way valve. The one-way valve 210 of FIGS. 2a-2c includes an elastic body 212 having a wedge portion 214 that extends from a first end toward a second end, and terminates in a slit 216 at the second end. When pressure is applied to the first end, the pressure acts on the wedge portion 214 and forces the slit 216 open. Sufficient pressure will force an opening at the second end, thus opening the valve 210. Pressure applied to the second end does not cause the slit to open. Such a valve allows fluid to move only from the first end to the second end (in the direction of the arrow), and then only if the opening pressure is applied to the first end. In some embodiments, the one-way valve 210 may be a silicone rubber valve similar to those used to reseal wine bottles.

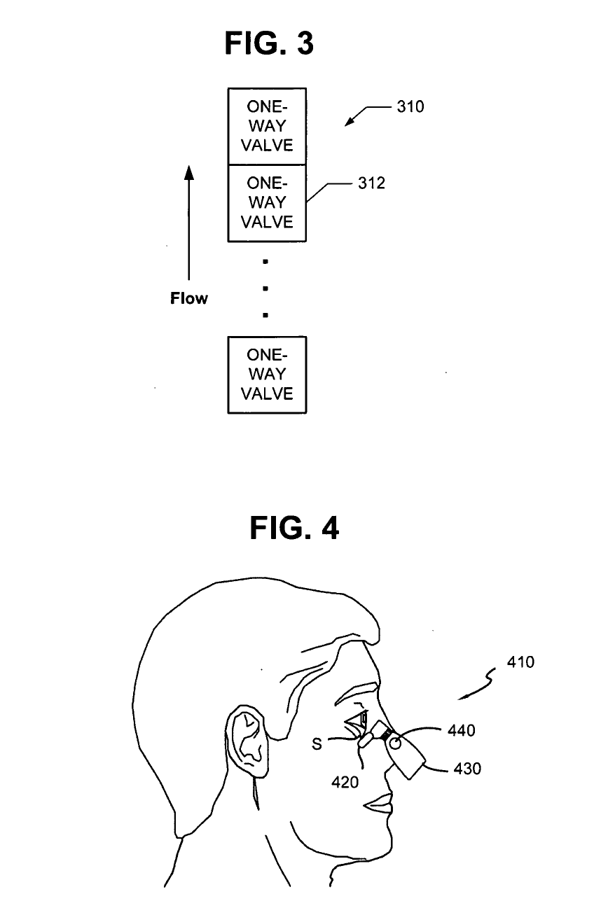

FIG. 3 illustrates an array 310 of one-way valves 312 in series that collectively open when an opening pressure is applied from one direction, but collectively seal when this pressure is removed. This arrangement provides a better seal than a single valve, resulting in less chance for microbial contamination, and less seepage of gas or liquid over time. A preferred number of valves would be from three to five. The one-way valves could be any type of known check valve utilizing a ball, reed, or poppet design, or they could be any of the valves described above.

A fluid dispenser described herein may further include a means 190 for sterilizing the exit orifice 140. Any fluid remaining in the exit orifice 140 (downstream from the one-way valve 170) will be sterilized. As a first example, a surface at the exit orifice 140 is coated with an anti-microbial material (e.g., silver) 190. Fluid downstream from the one-way valve 170 is in contact with the coated surface. As a second example, a silver coil 190 is located at the exit orifice 140. Fluid downstream from the one-way valve 170 is in contact with the coil 190.

A fluid dispenser described herein is not limited to dispensing any particular fluid. As but one example, a fluid dispenser described herein may be used to dispense liquid nasal medications.

As another example, a fluid dispenser described herein can be used to dispense preservative-free eye drops. The one-way valve prevents unsterilized air from entering the fluid container, thus preventing contamination of the eye drops in the fluid container.

Reference is now made to FIG. 4, which illustrates an eye drop dispenser 410. The eye drop dispenser 410 includes a dispensing section described herein and also a contoured eye-positioning section 420. The contoured section 420 may perform any or all of the following tasks: (1) opens the lower eye conjunctival sac S to form a “well” to hold the eye drop; (2) maintains the user's hand steady when operating the device; (3) prevents closing of the lower eyelid when dispensing eye drops; and (4) helps to aim the dispensing exit orifice. The contoured positioning section 420 allows a user to position an eyelid using only one hand without having to touch the face with fingers. The contoured section 420 may be attached to the fluid container 430 or the dispensing section. A user can apply liquid eye drops with one hand, while maintaining the head erect and a level gaze. A precise volume of liquid can be consistently administered, regardless of the level of liquid in the container.

A fluid dispenser described herein may also include a means for expelling a metered volume out of the exit orifice. Consider a first example in which the walls of the fluid container 160 of FIG. 1 are flexible. Squeezing the walls increases pressure at the fluid inlet 150 of the dispensing section 120, and forces the metered portion through the one-way valve 170.

Now consider a second example in which the fluid container 430 of FIG. 4 has rigid walls and a flexible button 440. The button 440 is stable only in a normal position or a depressed position. When depressed, the button 440 snaps into the depressed position and provides a substantially reproducible increase in pressure to discharge the metered volume through the exit orifice. The change in the pressure within the container is directly proportional to the change in the internal volume of the button.

As the metered volume of fluid is expelled, the volume of the fluid container may be reduced without allowing microbial contamination into the fluid container. As a first example, fluid in the container is stored in a collapsible bag. As fluid is expelled from the bag, the bag collapses. The collapsible bag may have the shape of an accordion.

As a second example, a piston is located at the bottom of the fluid container, and a spring biases the piston upward (toward the dispensing chamber). A metered volume is expelled, for example, by pressing a button. The button activates a ratchet assembly that allows the piston to move upward by a fixed distance. In this manner, the volume of the fluid container is reduced by a fixed amount each time a metered volume of fluid is dispensed.

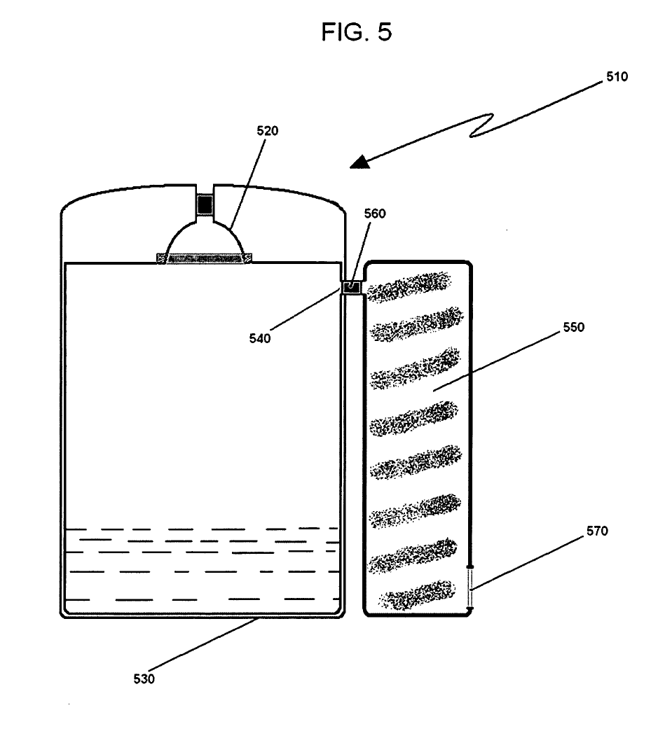

Instead of reducing the volume of the fluid container, the expelled fluid (and also expelled air) may be replaced with a sterile gas. Different examples of replacing the metered volume with a sterile gas are illustrated in FIGS. 5-7. The replacement is performed without allowing microbial contamination into the fluid container, thus maintaining sterility of the fluid in the container.

Reference is made to FIG. 5. A fluid dispenser 510 includes a dispensing section 520 as described herein and a fluid container 530 having an air inlet 540. An air filter 550 and a one-way inlet valve 560 are disposed within the air inlet 540. The fluid container 530 is vented to ambient through the air filter 550. The one-way inlet valve 560 allows filtered ambient air to flow into the fluid container 530. The air filter 550 is adjacent to the fluid container 530, and is completely closed except for two (small) openings: an air intake 570 and the air inlet 540. After a metered volume is expelled (e.g., by squeezing the fluid container 530), ambient air is drawn into the air intake 570, flows through the air filter 550 (trapping any microbes), through the air inlet 540, through the one-way inlet valve 560, and into the fluid container 530. In this manner, the replacement air is sterilized by the air filter 550 before reaching the fluid container 530.

In some embodiments, the air filter 550 may have a metal coating that prevents microbial growth. In some embodiments, the air filter 550 may have a micropore matrix that traps and removes microbial elements from ambient air.

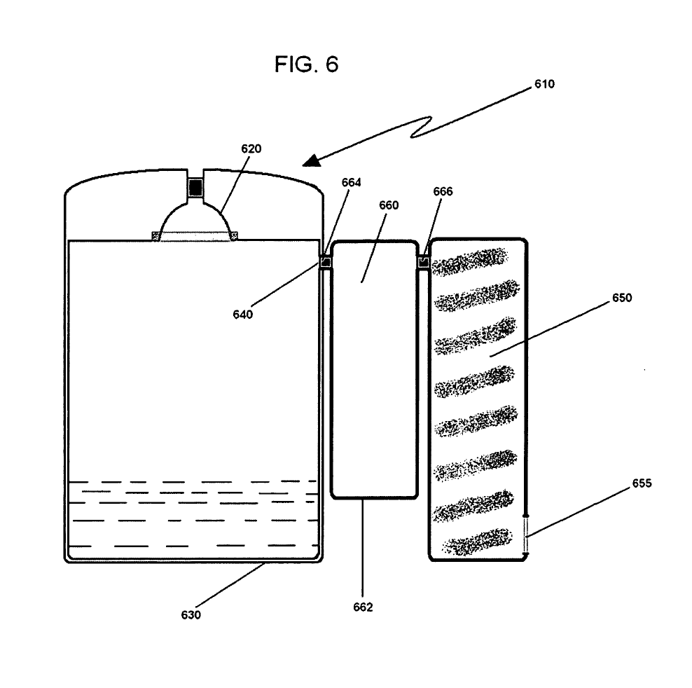

Reference is made to FIG. 6. A fluid dispenser 610 includes a dispensing section 620 as described herein and a fluid container 630 having an air inlet 640. An anti-microbial air filter 650 and air pump 660 are attached to the fluid container 630. The pump 660 may include a flexible bellows 662 with two one-way valves 664 and 666. The pump 660 may be operated by squeezing and releasing it.

When the pump 660 is squeezed, positive pressure forces sterile air (contained in the pump) through the air inlet 640 and into the fluid container 630. Valve 666 prevents air in the pump 660 from entering the filter 650. When the pump 660 is released, negative pressure draws ambient air into the filter 650 via an air intake 655, and then into the bellows 662 via the valve 666. Valve 664 prevents liquid from being drawn out of the fluid container 630 into the pump 660.

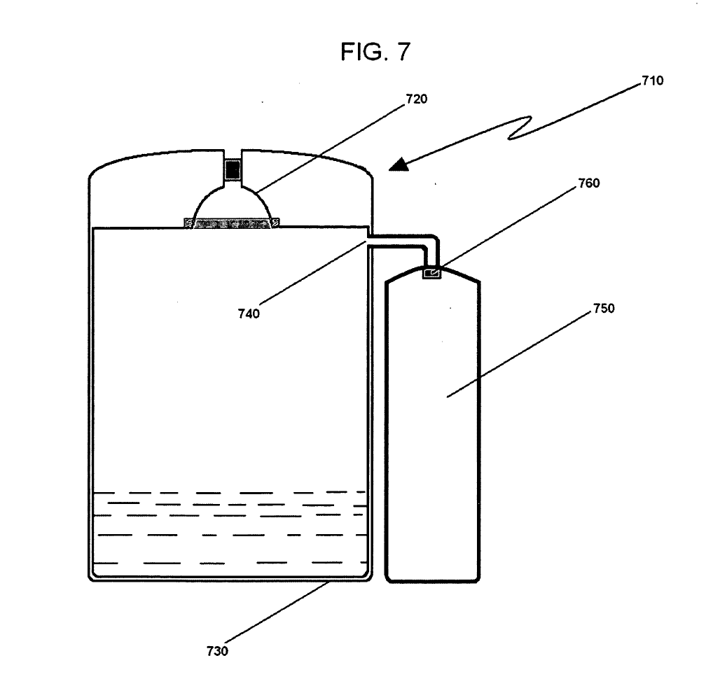

Reference is made to FIG. 7. A fluid dispenser 710 includes a dispensing section 720 as described herein and a fluid container 730 having an air inlet 740. A pressurized container 750 of sterile inert gas is attached to the fluid container 730.

The pressurized container 750 can inject a fixed volume of gas through the inlet 740 and into the fluid container 730. The fixed volume may be metered by a valve 760. When the valve 760 is actuated, a fixed volume of gas is injected into the fluid container 730, and it forcefully expels the metered fluid volume, as well as replaces the expelled fluid.

The sterile inert gas could be nitrogen, chlorofluorocarbon (CFC), hydrofluorocarbon (HFC), or other gas. Once inside the fluid container 730, the sterile inert gas can help to prevent microbial growth by depleting oxygen.

1. Apparatus for metering and dispensing fluid, the apparatus comprising:
a fluid dispensing section having an exit orifice, a fluid inlet, and a pathway extending from the fluid inlet to the exit orifice, a portion of the pathway including a hydrophilic portion for metering a volume of the fluid when the dispensing section is upright; and a hydrophobic ring at the fluid inlet, the ring for preventing a metered volume from flowing out of the hydrophilic portion when the dispensing section is upright; and
a one-way valve between the exit orifice and the hydrophilic portion for allowing fluid to flow out of the hydrophilic portion and toward the exit orifice when sufficient pressure is applied to the fluid inlet, the one-way valve also preventing fluid from flowing through the exit orifice when the hydrophilic portion is being filled with fluid, whereby the one-way valve prevents unsterilized air and fluid from flowing back through the exit orifice and into the hydrophilic portion.

2. The apparatus of claim 1, wherein the one-way valve includes an elastic body having a wedge portion that extends from one end toward an opposite end, and terminates in a slit at the opposite end to permit movement of fluid or gas in only one direction.

3. The apparatus of claim 1, further comprising at least one additional one-way valve, wherein the one-way valves open and close collectively.

4. The apparatus of claim 1, further comprising a metallic surface at the exit orifice for sterilizing the orifice.

5. The apparatus of claim 1, further comprising an eye-positioning section.

6. The apparatus of claim 1, further comprising a fluid container, the fluid inlet of the dispensing chamber in fluid communication with the fluid container; wherein the one-way valve allows a metered volume of fluid to flow upstream from the valve to the exit orifice and prevents fluid upstream of the valve to flow into the fluid container.

7. The apparatus of claim 6, further comprising means for reducing volume of the fluid container when a metered volume is expelled, the volume reduced without allowing microbial contamination into the fluid container.

8. The apparatus of claim 6, further comprising means for replacing a metered volume that has been expelled, the metered volume replaced with a sterile gas without allowing microbial contamination into the fluid container.

9. The apparatus of claim 8, wherein the means includes a microbial air filter adjacent the fluid container, the fluid container vented to ambient through the air filter.

10. The apparatus of claim 8, wherein the means includes a microbial filter and an air pump for drawing ambient air through the filter and pumping a fixed volume of filtered air into the fluid container.

11. The apparatus of claim 8, wherein the means injects a fixed volume of sterile gas into the fluid container, thereby forcefully expelling the metered volume, as well as replaces the expelled volume.
